(19) United States
(12) Patent Application Publication
(10) Pub. No.: US 2014/0259421 A1
(43) Pub. Date: Sep. 18, 2014

(54) CUSHION STRUCTURE INTEGRATED WITH BODY SUPPORTING DEVICE

(71) Applicant: Hui-Mei CHEN, NewTaipei City (TW)

(72) Inventor: Hui-Mei CHEN, NewTaipei City (TW)

(21) Appl. No.: 13/826,346

(22) Filed: Mar. 14, 2013

(51) Int. Cl. A61G 13/12

(52) U.S. Cl. CPC A61G 13/12; A61G 13/126
USPC 5/621

(57) ABSTRACT

The cushion structure integrated with a body supporting device comprises: a decompression material, which is disposed on the body contacting surface of the cushion structure; a connection member, which connects with a surgical table or a fixture on the surgical table which support patient' entire body or a part of patient's body; and a decompression substrate, which is disposed between the decompression material and the connection member making the three of them as one component, wherein the connection member exposes a portion or a plurality of portions in order to connect with the surgical table or the fixture on the surgical table.

### BACKGROUND OF THE INVENTION

1. Field of the Invention

The present invention generally relates to a cushion structure integrated with a body supporting device, more particularly to cushion structure that integrates with a body supporting device and supports and protects the body portion of a user.

2. Description of the Prior Art

General auxiliary devices with health passports have two supporters to support the hands and legs of human bodies, and each of the two supporters has a cushion in order to let the hand or leg of a user be against the cushion. The cushion must have to support the weight of the user, so the user always feels the cushion hard. Thus the user may be uncomfortable while using for a long time.

As shown in FIG. 1, to figure out above shortcoming, having a decompression pad 2 on a cushion 1 is to let the user feel comfortable while the leg 3, face or arm, of the user is against the decompression pad 2. Since the decompression pad 2 is not fixed on the cushion 1, slippery condition happens all the time; and different positions are equipped with different decompression pads with different dimensions. Therefore, such applications are inconvenient.

A cushion structure integrated with a body supporting device can be designed to support and protect the body portion of a user, and the cushion structure has a certain flexibility and softness in order to let the user feel comfortable while the face, arm or leg is against the cushion structure; in addition, one more decompression cushion is not a need, and an approximate effect can be approached; further, a slippery condition may be avoided. As a result, the cushion structure integrated with a body supporting device is the best solution.

### SUMMARY OF THE INVENTION

The present invention provides a cushion structure integrated with a body supporting device, and the cushion structure integrates with the body supporting device in order to support and protect the body portion of a user.

To reach above objective, the cushion structure integrated with a body supporting device comprises: a decompression material, which is disposed on the body contacting surface of the cushion structure; a connection member, which connects with a surgical table or a fixture on the surgical table which support patient' entire body or a part of patient's body; and a decompression substrate, which is disposed between the decompression material and the connection member making the three of them as one component, wherein the connection member exposes a portion or a plurality of portions in order to connect with the surgical table or the fixture on the surgical table.

In practice, the decompression material is silicon, the outer layer of the silicon is wrapped around by a thermoplastic polyurethane film.

In practice, the decompression material is able to partially or completely wrap around the decompression substrate and the connection member.

In practice, the surface of the decompression material is a curved surface.

In practice, the surface of the decompression material is an irregular surface.

In practice, the connection member is made of plastic or metal.

In practice, the decompression substrate is foam.

In practice, the decompression substrate is silicon with harder hardness.

The cushion structure integrated with the body supporting device is bent to form a bending portion.

Other and further features, advantages, and benefits of the invention will become apparent in the following description taken in conjunction with the following drawings. It is to be understood that the foregoing general description and following detailed description are exemplary and explanatory but are not to be restrictive of the invention. The accompanying drawings are incorporated in and constitute a part of this application and, together with the description, serve to explain the principles of the invention in general terms. Like numerals refer to like parts throughout the disclosure.

### BRIEF DESCRIPTION OF THE DRAWINGS

The objects, spirits, and advantages of the preferred embodiments of the present invention will be readily understood by the accompanying drawings and detailed descriptions, wherein:

FIG. 1 illustrates a schematic view of a cushion for supporting the body portion of a human being of a prior art;

FIG. 2A illustrates a schematic 3-D view of the cushion structure integrated with a body supporting device of the present invention;

FIG. 2B illustrates a schematic sectional view of the cushion structure integrated with the body supporting device of the present invention;

FIG. 3A illustrates a schematic structural view of a first preferred embodiment of the cushion structure integrated with the body supporting device of the present invention;

FIG. 3B illustrates a schematic application view of the first preferred embodiment of the cushion structure integrated with the body supporting device of the present invention; and

FIG. 4 illustrates a schematic application view of a second preferred embodiment of the cushion structure integrated with the body supporting device of the present invention.

### DETAILED DESCRIPTION OF THE INVENTION

Following preferred embodiments and figures will be described in detail so as to achieve aforesaid objects.

With references to FIG. 2A and FIG. 2B, which illustrate a schematic 3-D view of the cushion structure integrated with the body supporting device of the present invention and a schematic sectional view of the cushion structure integrated with the body supporting device of the present invention. As shown in figures, the cushion structure 4 has a decompression material 41, a decompression substrate 42 and a connection member 43, wherein the decompression material 41 is disposed on the body contacting surface of the cushion structure 4, the decompression material 41 is silicon, the outer layer of the silicon is wrapped around by a thermoplastic polyurethane film, or the decompression material 41 is thermoplastic, the outer layer of the thermoplastic is wrapped around by a thermoplastic polyurethane film, and thus the decompression material 41 is able to partially or completely wrap around the decompression substrate 42 and the connection member 43, and the surface of the decompression material 41 has a curved surface 44 and a bending portion 45; in addition, the surface of the decompression material 41 is an irregular surface, such as bump, bump surface or particles, and user tightly touching onto the decompression material 41 with the irregular surface can approach the adventure of excellent ventilation and may not be afraid of long-time usage.

As shown in figures, since the decompression material 41 is softer, the weight of a user may lower down the decompression material 41 without the decompression substrate 42, so that the decompression substrate 42 is disposed between the decompression material 41 and the connection member 43. The decompression substrate 42 is foam or silicon of hardness harder than that of the decompression material 41. The decompression substrate 42 has two surfaces, one surface contacts with the decompression material 41 and another surface wraps around the connection member 43. Since the decompression substrate 42 is foam or silicon with harder hardness, the cushion structure 4 is with a certain flexibility to support the weight of the user, and therefore the user may not lower down to the connection member 43. Hence, the cushion structure 4 has the effects of more flexibility, softness and support while the decompression material 41 cooperating with the decompression substrate 42.

Further, the connection member 43 is made of plastic or metal, the connection member 43 exposes a portion or a plurality of portions thereof in order to connect with a surgical table or a fixture on the surgical table which support patient' entire body or a part of patient's body.

With references to FIG. 3A and FIG. 3B, the present invention makes the cushion structures 51 and 52 as a face cushion. According to figures, two surfaces of the two cushion structures 51 and 52 are bent to form two bending portions 512 and 522. The head of the user 6 can lower down to be between the cushion structures 51 and 52 in order to let the face 61 of the user 6 be on the decompression materials 511 and 521 of the cushion structures 51 and 52. The two bending portions 512 and 522 just fit the face 61 of the user 6, so that the user 6 is able to comfortably lie face downwards for being between the cushion structures 51 and 52.

Since the cushion structure is applicable to face, arm or leg, different appearances may be for different applications, but it still has the decompression material, the connection member and the decompression substrate. As shown in FIG. 4, the present invention further makes the cushion structure 7 as a leg cushion. According to figure, the central of the cushion structure 7 is an indentation to accommodate the leg 8 of a user. The decompression material 71 of the cushion structure 7 partially wraps around the decompression substrate 72, and the decompression substrate 72 partially wraps around the connection member 73 as well. Therefore, the portion of the connection member 73 not wrapped around by the decompression substrate 72 is exposed to outwardly connect with a metal frame 9 for raising the cushion structure 7.

While the leg 8 is against the decompression material 71 of the cushion structure 7, the cushion structure 7 has the flexibility to support the leg 8 so as to let the leg 8 be comfortably on the decompression material 71 due to the decompression substrate 72 of the cushion structure 7 being made of foam or silicon with harder hardness.

Compared to prior arts, the cushion structure integrated with a body supporting device provided by the present invention has the following adventures listed below:
1. The present invention is to support and protect the body portion of a user. The cushion structure has a certain support, flexibility and softness, hence an uncomfortable condition may not happen while the body portion is against the cushion structure; in addition, one more decompression cushion is not a need, and an approximate effect can be approached; further, a slippery condition may be avoided.
2. The present invention is capable of integrating with general human body supporting devices with health passports, therefore the body portion can be against the cushion structure while a user uses the general human body supporting device; more, the user may be against or lie on the cushion structure for a long time without uncomfortableness since the cushion structure has a certain flexibility and softness.

Although the invention has been disclosed and illustrated with reference to particular embodiments, the principles involved are susceptible for use in numerous other embodiments that will be apparent to persons skilled in the art. This invention is, therefore, to be limited only as indicated by the scope of the appended claims

What is claimed is:

1. A cushion structure integrated with a body supporting device comprising:
a decompression material, disposed on the body contacting surface of the cushion structure;
a connection member, connecting with a surgical table or a fixture on the surgical table which support patient' entire body or a part of patient's body; and
a decompression substrate, disposed between the decompression material and the connection member making the three of them as one component, wherein the connection member exposes a portion or a plurality of portions in order to connect with the surgical table or the fixture on the surgical table.

2. The cushion structure integrated with the body supporting device according to claim 1, wherein the decompression material is silicon, the outer layer of the silicon is wrapped around by a thermoplastic polyurethane film.

3. The cushion structure integrated with the body supporting device according to claim 1, wherein the decompression material is thermoplastic, the outer layer of the thermoplastic is wrapped around by a thermoplastic polyurethane film.

4. The cushion structure integrated with the body supporting device according to claim 1, wherein the surface of the decompression material is a curved surface.

5. The cushion structure integrated with the body supporting device according to claim 1, wherein the surface of the decompression material is an irregular surface.

6. The cushion structure integrated with the body supporting device according to claim 1, wherein the connection member is made of plastic or metal.

7. The cushion structure integrated with the body supporting device according to claim 1, wherein the decompression substrate is foam.

8. The cushion structure integrated with the body supporting device according to claim 1, wherein the decompression substrate is silicon of hardness harder than that of the decompression material.
